(19) United States
(12) Patent Application Publication
(10) Pub. No.: US 2026/0112663 A1
(43) Pub. Date: Apr. 23, 2026

(54) REDOX FLOW BATTERY AND METHOD FOR OPERATING SAME

(71) Applicant: Liva Power Management Systems GmbH, Frankfurt am Main (DE)

(72) Inventors: Thomas Lüth, Freiburg (DE); Christian Hättich, Freiburg (DE); Yifeng Li, Steinheim (DE)

(21) Appl. No.: 19/111,582

(22) PCT Filed: Aug. 7, 2023
(86) PCT No.: PCT/EP2023/071769

§ 371 Date: Mar. 13, 2025

(30) Foreign Application Priority Data
Sep. 16, 2022 (DE) 10 2022 123 821.0

(51) Int. Cl. H01M 8/04186; H01M 8/04082; H01M 8/04276; H01M 8/04537; H01M 8/18

(52) U.S. Cl. CPC H01M 8/04186; H01M 8/04201; H01M 8/04276; H01M 8/04544; H01M 8/04604; H01M 8/188

(57) ABSTRACT

A redox flow battery includes a cell arrangement and a measuring apparatus for determining the charging state. The measuring apparatus comprises includes a hydraulic connecting line which connects the first tank to the second tank so that there is a permanent electrical connection between the electrolyte liquids in the two tanks. The measuring apparatus includes at least two electrodes. A first electrode is arranged directly in the positive electrolyte circuit. A second electrode is arranged directly in the negative electrolyte circuit. The redox flow battery includes a control apparatus which is designed such that it can detect a voltage difference between two electrodes.

### FIELD

The invention relates to a redox flow battery comprising a measuring device for determining the state of charge and a method for operating the redox flow battery. The redox flow battery is preferably a battery based on vanadium. However, also batteries with differently composed electrolytes are possible.

### BACKGROUND

To determine the state of charge (SoC) of a redox flow battery, electrochemical measuring cells are usually used by means of which the open-circuit voltage (OCV) of the battery can be measured. The use of such measuring cells is disclosed, for example, in DE 10 2020 115 385 B3. Such a measuring cell comprises two chambers, which are separated from each other by a so-called separator or membrane. In each chamber an electrode is arranged between which the measuring signal is tapped. The chambers of the measuring cell are connected to the electrolyte circuit of the battery so that electrolyte can flow through the chambers.

### SUMMARY

It is the object of the invention to provide an alternative arrangement for at least approximately determining the SoC of a redox flow battery, wherein no electrochemical measuring cell is required.

The object is achieved according to the invention by an embodiment according to the independent claim. Further advantageous embodiments of the present invention can be found in the sub-claims.

### BRIEF DESCRIPTION OF THE DRAWINGS

The invention is explained below with reference to figures. The figures show in detail:

FIG. 1 a redox flow battery according to the invention;

FIG. 1a variants of the hydraulic connection line according to the invention;

FIG. 2 an arrangement of electrodes according to the invention; and

FIG. 3 a further arrangement of electrodes according to the invention;

### DETAILED DESCRIPTION

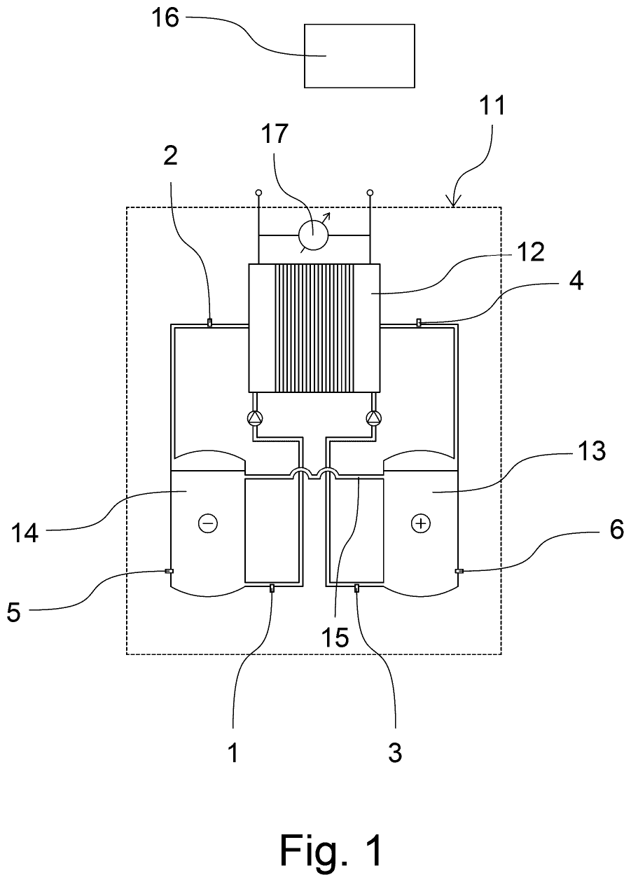

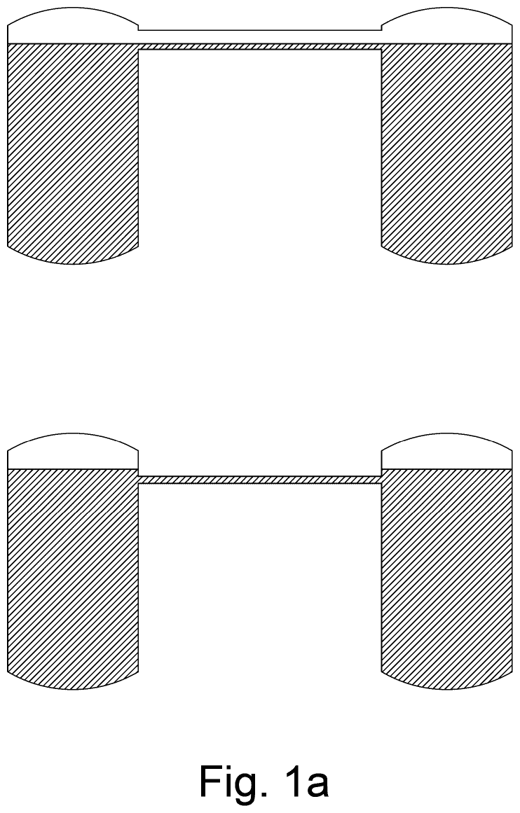

FIG. 1 shows a redox flow battery designated with 11. The battery comprises a cell assembly designated with 12. The cell assembly 12 is an assembly of a plurality of redox flow cells that can be arranged arbitrarily. For example, it could be a single cell stack, a series connection of several stacks, a parallel connection of several stacks, or a combination of series and parallel connection of several stacks. The battery 11 comprises two tanks for storing electrolytes. The tanks are designated with 13 and 14. The plus and minus signs drawn in the tanks 13 and 14 indicate the polarity of the electrolyte contained in the respective tank.

During the operation of such a battery 11, electrolyte is supplied from each of the two tanks 13 and 14 to the cell assembly 12. Herein, a respective tank 13 or 14 and a pipe system between the corresponding tank and a respective inlet of the cell assembly 12 each form a supply system for electrolyte. In a similar way, a pipe system between an outlet of the cell assembly 12 and a tank forms a discharge system for electrolyte. A battery 11 thus comprises two supply systems and two discharge systems for electrolyte. Here, a supply system and the associated discharge system form a circuit for electrolyte. To distinguish them, the individual supply systems, discharge systems and circuits are designated by the terms “negative” and “positive”, which refer to the polarity of the electrolyte in the elements mentioned. A pump impeller is provided in each circuit to circulate electrolytes. As a rule, the pump impellers are arranged in the supply systems. The direction of rotation of the pump impellers determines the direction in which the electrolyte is circulated in the respective circuit. This direction is also determined by the fact that the opening of the pipe system into the tank for the supply system is arranged in the lower part of the tank, while the opening of the pipe system into the tank for the discharge system is arranged in the upper part of the tank, as shown in FIG. 1.

The measuring device of a battery 11 according to the invention comprises at least two electrodes which are arranged directly in the electrolyte circuits. A first electrode is arranged directly in the negative electrolyte circuit and a second electrode is arranged directly in the positive electrolyte circuit. The electrodes are therefore in contact with the electrolyte and allow a potential to be tapped which can characterize the state of the electrolyte. FIG. 1 shows a total of six such electrodes. One electrode is designated with 1 and arranged directly in the pipe system of the negative supply system. A further electrode is designated with 2 and is arranged directly in the pipe system of the negative discharge system. A further electrode is designated with 3 and is arranged directly in the pipe system of the positive supply system. A further electrode is designated with 4 and arranged directly in the pipe system of the positive discharge system. A further electrode is designated with 5 and is arranged directly in tank 14 of the negative supply system. A further electrode is designated with 6 and is arranged directly in tank 13 of the positive supply system. The term “directly” is used to indicate that the corresponding electrodes are arranged directly in the mentioned elements and not, as known from the prior art, in separate measuring cells that are connected to the electrolyte circuits via branch lines.

As described in more detail further below, according to the invention the measuring signal, which represents a measure of the state of charge of the battery, consists of a voltage difference between the first and the second electrode. The prerequisite for this is that there is a defined reference potential for the respective potentials of the two electrolyte circuits. In other words, the two electrolyte circuits must not float against each other in an electrical point of view. According to the invention, this is achieved in that the two electrolyte circuits are electrically connected to each other via a hydraulic connecting line, which is described in more detail in the next section.

A battery 11 according to the invention comprises a hydraulic connecting line that permanently electrically connects the electrolyte liquid in the two tanks 13 and 14 to one another. In FIG. 1, the connecting line is designated with 15. Since the walls of the connecting line 15 are made of a non-conductive material (as is usually the case for all electrolyte liquid-conducting pipes in redox flow batteries of the type in question), the electrical connection is established by the electrolyte liquid that is arranged in the connecting line 15, since the connecting line 15 filled with an electrolyte represents a salt or ion bridge. Such a hydraulic connection line 15 is thus a necessary component of the measuring device according to the invention. In connection with FIG. 1a, two variants of hydraulic connection lines are described, by means of which the electrical connection of the electrolyte circuits necessary for the measuring device can be accomplished.

Hydraulic connection lines between the two tanks of a redox flow battery are known from the prior art. For example, WO 2022/033 750 A1 discloses such a hydraulic connection line (see FIG. 5). The disclosed hydraulic connection line opens into the tanks above the electrolyte levels and serves to enable an exchange of electrolyte liquid between the two tanks when the quantities of electrolyte liquid in the two tanks differ from each other. In WO 2022/033 750 A1, the different quantities occur when the electrolyte liquid is mixed. Even in the normal operation of a redox flow battery, a so-called “cross-over” in the cell assembly can cause the quantities of electrolyte liquid in the two tanks to differ over time. In this case, too, hydraulic connection lines, as disclosed in WO 2022/033 750 A1, can be used to equalize the levels in the two tanks again if they have shifted against each other beyond a predetermined amount. Such known hydraulic connection lines therefore only allow an electrical connection of the electrolyte circuits at times (i.e. not permanently). Since such an electrical connection in principle leads to an undesired discharge of the redox flow battery, conventional redox flow batteries are sometimes equipped with shut-off valves in such hydraulic connection lines in order to be able to actively prevent such a discharge.

FIG. 1a shows two variants for hydraulic connection lines according to the invention. In the lower part of FIG. 1a, the hydraulic connection line is designed in such a way that the two openings into the tanks are respectively arranged completely below the electrolyte level. Thus, the entire hydraulic connection line is permanently filled with electrolyte liquid. In this variant, the pipe cross-section of the hydraulic connection line is advantageously kept small, so that hardly any exchange of electrolyte liquid takes place through the hydraulic connection line. The current flowing through the hydraulic connection line is then also negligibly small, since the electrical connection is high-impedance. As a rule, small pipe diameters are also sufficient to compensate for the inequalities of the electrolyte fluids caused by crossover. In the variant shown in FIG. 1a at the top, the hydraulic connection line is designed so that the two openings into the tanks are arranged only partially below the electrolyte level. Therefore, the hydraulic connection line is only partially permanently filled with electrolyte liquid. Even a partial filling with electrolyte liquid is sufficient to establish a permanent electrical connection. To this end, the hydraulic connection line must extend horizontally with sufficient accuracy. In this variant, the connection line can also have a large cross-section, since the connection line is only partially filled with electrolyte liquid, so that a high-impedance electrical connection is also present in this case. Therefore, such a connecting line can also be used advantageously for mixing the electrolyte liquids in the tanks (as described in WO 2022/033 750 A1).

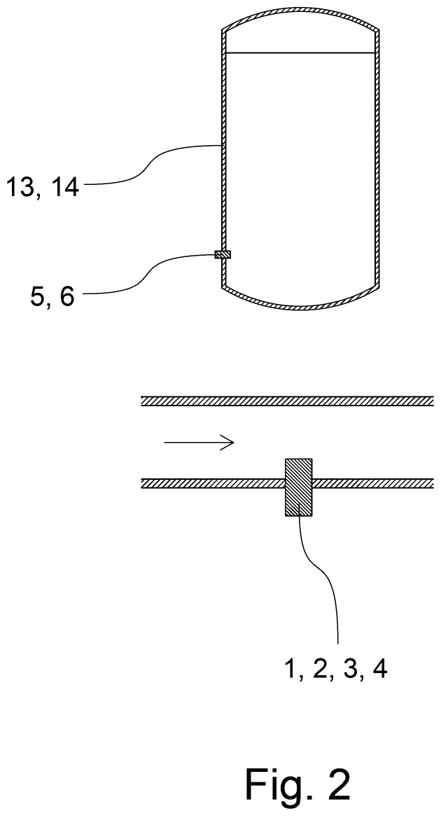

FIG. 2 shows the arrangement of the electrodes in detail. In the upper part of the figure, an electrode is arranged in a tank. The electrode penetrates the tank wall. In the lower part of the figure, an electrode is arranged in a pipe system. The electrode penetrates the wall of the pipe system. Here, the walls are made of a non-conductive material. Alternatively, the electrodes can be arranged completely inside the respective elements (tank or pipe system). In this case, an electrical line leads from the electrodes through the walls of the respective elements into the external space.

It is advantageous if the electrodes in the two circuits are arranged in approximately the same way. That means, with reference to FIG. 1: If the first electrode in the negative circuit is arranged like electrode 1, then the second electrode in the positive circuit should be arranged like electrode 3. If the first electrode in the negative circuit is arranged like electrode 2, then the second electrode in the positive circuit should be arranged like electrode 4. If the first electrode in the negative circuit is arranged like electrode 5, then the second electrode in the positive circuit should be arranged like electrode 6. However, minor deviations from the optimal arrangement do not play a decisive role.

The two electrodes serve to provide a measuring signal that represents a measure of the state of charge SoC of the battery 11. The measuring signal consists of a voltage difference between the first and the second electrode. A control device, which is designated with 16 in FIG. 1, is used to detect this voltage difference. Although the control device 16 can be spatially separated from the battery 11, as shown in FIG. 1, it is considered to be part of the battery 11. The control device 16 could as well be integrated into the battery 11. If the battery 11 is part of a larger battery system, the control device 16 can be integrated into a higher-level control system. In any case, the control device 16 is connected to the at least two electrodes 1, 2, 3, 4, 5 and/or 6 arranged in the electrolyte circuit, insofar as these are present.

Depending on where the two electrodes are arranged, the voltage difference between them indicates a different state of charge. Thus, the voltage difference V₁₃ between the electrodes 1 and 3 of FIG. 1 represents the state of charge of the electrolyte before it enters the cell assembly 12. Similarly, the voltage difference V₂₄ between the electrodes 2 and 4 represents the state of charge of the electrolyte after it has passed through the cell assembly 12. Accordingly, the voltage difference V₅₆ between the electrodes 5 and 6 represents the state of charge of the electrolyte in the tanks 13 and 14.

If the battery 11 comprises more than one electrode per electrolyte circuit, then further voltage differences can be formed, which can provide additional information about the state of the battery 11. The information that can be obtained, when the battery 11 comprises the electrodes 1, 2, 3 and 4 from FIG. 1, is particularly interesting. Thus, the difference (V₁₃-V₂₄) represents the difference in the state of charge of the electrolyte before and after passing through the cell assembly 12. This difference also represents a measure of the flow rate of the electrolyte through the cell assembly. It can therefore be used as a control signal for the pump delivery rate. This makes it possible to dispense with pressure sensors in the electrolyte circuit, which are conventionally used to provide a control signal for the pump delivery rate. In addition, the voltage difference V₂₁ between the electrodes 2 and 1 is a measure of the conversion rate of the negative half of the cell assembly 12. Similarly, the voltage difference V₄₃ between the electrodes 4 and 3 is a measure of the conversion rate of the positive half of the cell assembly 12. These quantities can be used to detect undesired secondary reactions in the cell assembly 12 and to obtain information about the remaining state of health (SoH) of the battery. In addition, the Coulomb efficiency (CE) of the cell assembly 12 can be estimated.

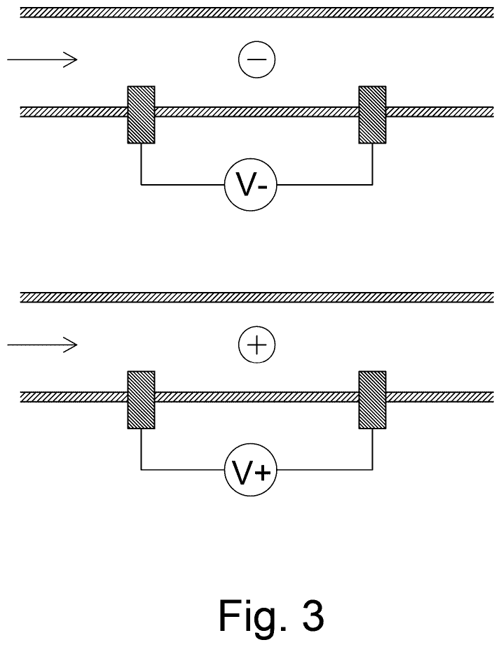

If more than two electrodes are respectively arranged in the electrolyte circuits, then the same can also be used to detect an imbalance between the negative and positive electrolytes with respect to their respective state of charge. The conditions under which this is possible are explained in more detail based on FIG. 3. FIG. 3 shows a part of the negative electrolyte circuit at the top and a part of the positive electrolyte circuit at the bottom. The arrows indicate the direction of flow of the electrolyte. In each part, two electrodes are arranged, wherein one of the electrodes is arranged upstream in the direction of flow and the other is arranged downstream in the direction of flow. The hydraulic path length between the two electrodes is defined as the distance traveled by the electrolyte as it flows from the electrode arranged upstream to the electrode arranged downstream. A respective voltage is measured between the two electrodes belonging to the same circuit: V− and V+. If V− differs from V+, this indicates an imbalance with respect to the state of charge of the two electrolytes. However, in this case the hydraulic path length between the two electrodes in both circuits must be as equal as possible. Furthermore, the cell assembly 12 must not be arranged in the hydraulic path between the two electrodes. That means, with reference to FIG. 1, the electrodes 5 and 1 and 6 and 3 or the electrodes 2 and 5 and 4 and 6 could be used for such an evaluation. However, it is not possible to use the electrodes 1 and 2 and 3 and 4, because in this case the cell array 12 is arranged in the hydraulic path between the electrode pairs. The condition of the same hydraulic path length between the electrode pairs can be particularly easily met if all participating electrodes are arranged in the tank.

In the arrangement shown in FIG. 3, one of the electrodes per electrolyte circuit can respectively be regarded as a so-called working electrode and the other electrode as a reference electrode. V− and V+ then represent the difference in potential between the working and the reference electrode. This is particularly important if more than two electrodes are used per electrolyte circuit. In this case, there is exactly one reference electrode and more than one working electrode per electrolyte circuit, and the potential differences are formed in relation from a working electrode to the reference electrode. It is clear that the electrodes in the individual electrolyte circuits are arranged at equivalent positions.

Thus, in summary, it can be said that with the help of respectively one electrode per electrolyte circuit, a measure for the state of charge (SoC) of the battery can be obtained. With more than one electrode per electrolyte circuit, moreover, further interesting characteristics of the battery can be determined or estimated.

Carbon can be used as the material for the electrodes. This could be graphite or glassy carbon, for example. Moreover, conductive plastics are possible materials. If the redox flow battery is a vanadium-based battery, it is advantageous if the electrodes are also based on vanadium as material. This could be a plastic comprising vanadium oxide (i.e. V₂O₅, for example) and carbon as an active material.

The method according to the invention for determining the state of charge SoC of the battery 11 comprises the following steps:
detecting the electrical voltage at the first electrode
detecting the electrical voltage at the second electrode
calculating the voltage difference of the voltages detected in the two preceding steps

As described above, the first electrode is arranged in the negative electrolyte circuit and the second electrode is arranged in the positive electrolyte circuit.

To determine further characteristics of the battery, the battery comprises at least four electrodes, wherein at least two electrodes are arranged in the negative electrolyte circuit and at least two electrodes are arranged in the positive electrolyte circuit. The method according to the invention then additionally comprises the following steps:
detecting the electrical voltage at two electrodes of the negative electrolyte circuit
detecting the electrical voltage at two electrodes of the positive electrolyte circuit
calculating the voltage differences of the voltages measured in the two preceding steps separately for each electrolyte circuit

The inventors have found that the reliability of determining the SoC of the battery can be statistically increased by combining several methods for determining the SoC. Thus, the value for the state of charge SoC determined according to the invention as described above can be made more precise by determining the SoC of the respective electrolyte circuit from the voltage differences V− and/or V+. Another possible combination is to estimate the state of charge of the battery in addition by use of the terminal voltage of the battery. For this purpose, the battery optionally includes a measuring device for measuring the terminal voltage. Such a measuring device is designated with 17 in FIG. 1. To estimate the state of charge SoC by use of the terminal voltage the following steps are carried out:
switching off the power to the cell assembly
detecting the terminal voltage after a predefined period of time has elapsed
dividing the terminal voltage by the number of serially arranged cells in the cell assembly

Switching off the power to the cell assembly means that the battery will not be charged or discharged from this step onwards. The predefined period of time that must then elapse in this state depends on the flow rate at which the pumps are currently operating and the electrolyte volume of the cell assembly. If the volume of the cell assembly has been completely filled with fresh electrolyte, a state is achieved in which the terminal voltage corresponds to the open-circuit voltage multiplied by the number of cells of the cell assembly arranged in series.

By combination with other known methods for determining the state of charge the reliability can be further increased. Such known methods are, for example, so-called “Coulomb counting” or determining the state of charge by use of optical sensors (see, for example, DE 10 2016 117 604 A1).

### LIST OF REFERENCE SYMBOLS

1 electrode
2 electrode
3 electrode
4 electrode
5 electrode
6 electrode
11 redox flow battery
12 cell assembly
13 tank
14 tank
15 hydraulic connecting line
16 control device
17 measuring device for detecting the terminal voltage

1. A redox flow battery comprising:
a cell assembly comprising two inlets and two outlets for electrolyte;
a first tank for storing positive electrolyte liquid;
a second tank for storing negative electrolyte liquid;
two first pipe systems between the first and second tanks and the inlets of the cell assembly;
two second pipe systems between the first and second tanks and the outlets of the cell assembly,
wherein the first and second tanks and the first pipe systems form two supply systems,
wherein the second pipe systems form two discharge systems,
wherein a respective supply system and a respective discharge system form a negative electrolyte circuit and a respective supply system and a respective discharge system form a positive electrolyte circuit, and
wherein a pump impeller for circulating the electrolyte is arranged in each electrolyte circuit;
a measuring device for determining the state of charge,
wherein the measuring device for determining the state of charge comprises a hydraulic connecting line which connects the first tank to the second tank in such a way that there is a permanent electrical connection between the electrolyte liquids in the first and second tanks,
wherein the electrical connection is established by electrolyte liquid which is disposed in the hydraulic connecting line,
wherein the measuring device comprises at least two electrodes and
wherein a first electrode of the at least two electrodes is arranged directly in the positive electrolyte circuit and a second electrode of the at least two electrodes is arranged directly in the negative electrolyte circuit; and
a control device configured to detect a voltage difference between two electrodes.

2. The redox flow battery according to claim 1, wherein at least some electrodes of the at least two electrodes are arranged directly in the supply systems.

3. The redox flow battery according to claim 2, wherein at least some electrodes of the at least two electrodes are arranged directly in the pipe systems of the supply systems.

4. The redox flow battery according to claim 2, wherein at least some electrodes of the at least two electrodes are arranged directly in the first and second tanks.

5. The redox flow battery according to claim 1, wherein at least some electrodes of the at least two electrodes are arranged directly in the discharge systems.

6. The redox flow battery according to claim 1, wherein the redox flow battery comprises more than one electrode of the at least two electrodes per electrolyte circuit.

7. The redox flow battery according to claim 6, wherein respectively one electrode of the at least two electrodes is arranged directly in the supply systems and respectively one electrode of the at least two electrodes is arranged directly in the discharge systems.

8. The redox flow battery according to claim 7, wherein respectively one electrode of the at least two electrodes is arranged directly in the pipe systems of the supply systems.

9. The redox flow battery according to claim 6, wherein the control device is configured to detect a voltage difference between two electrodes of the at least two electrodes which are arranged in the same electrolyte circuit.

10. The redox flow battery according to claim 1, another measuring device for detecting a terminal voltage.

11. A method for operating a redox flow battery according to claim 1, the method comprising the following steps:
detecting the voltage at the first electrode;
detecting the voltage at the second electrode; and
calculating the voltage difference of the voltage detected in the two preceding steps,
wherein the voltage difference is a measure of the state of charge of the battery.

12. A method for operating a redox flow battery according to claim 6, the method comprising the following steps:
detecting the electrical voltage at two electrodes of the negative electrolyte circuit;
detecting the electrical voltage at two electrodes of the positive electrolyte circuit; and
calculating the voltage differences of the voltages detected in the two preceding steps separately for each electrolyte circuit.

13. A method for operating a redox flow battery according to claim 10, the method comprising the following steps:
detecting the voltage at the first electrode;
detecting the voltage at the second electrode;
calculating the voltage difference of the voltage detected in the two preceding steps,
wherein the voltage difference is a measure of the state of charge of the battery;
switching off the power to the cell assembly;
detecting the terminal voltage after a predefined period of time has elapsed; and
dividing the terminal voltage by the number of serially arranged cells in the cell assembly;
wherein the quotient obtained in the last-mentioned step represents a measure of the state of charge of the battery.
